(19) United States
(12) Patent Application Publication
(10) Pub. No.: US 2006/0042658 A1
(43) Pub. Date: Mar. 2, 2006

(54) Dishwasher absolute clean cycle methods and systems

(75) Inventor: Kevin J. Engler, Freeport, IL (US)

Correspondence Address: Honeywell International, Inc.;Intellectual Property, 101 Columbia Rd., P.O. Box 2245, Morristown, NJ, 07962, US

(73) Assignee: Honeywell International, Inc.

(21) Appl. No.: 10/933,043

(22) Filed: Sep. 2, 2004

(51) Int. Cl. B08B 7/04; B08B 9/20; B08B 3/00

(52) U.S. Cl. 134/18; 134/25.1; 134/34; 134/56 D; 134/58 D

(57) ABSTRACT

Dishwasher cycle methods and systems are disclosed. A dishwasher can be equipped with a humidity sensor for monitoring humidity with the dishwasher in order to provide optimum humidity and heat during a dishwashing cycle thereof, thereby allowing the humidity and heat to modified in order to allow the soil (e.g., food soil) to soften for subsequent washing and/or rinsing during a dishwasher cycle thereof. A turbidity sensor is also provided for automatically monitoring the turbidity within the dishwasher in order to detect a cleaning action thereof to determine if the soil has been released from articles, such as dishes, within said dishwasher. Additionally, a spray injector can be utilized for injecting a spray into the dishwasher prior to the dishwashing cycle in order to release soil from the articles contained therein and provide humidity for the removal of the soil.

### TECHNICAL FIELD

Embodiments are generally related to machines for washing articles, such as dishwashers. Embodiments are also related to sensors, such as turbidity sensors and humidity sensors. Embodiments are also related to methods and systems for regulating and monitoring heat, humidity and the amount of fluid consumed by machines for washing articles.

### BACKGROUND OF THE INVENTION

Automatic dishwashers have been known to those skilled in the art for many years. Most different dishwashers operate in a generally similar manner. For example, dishwashers made for use in the United States typically incorporate a single pump. The pump can be driven in one direction to circulate water and cause the water to be sprayed against the dishes. When driven in an opposite direction, the pump can be used to drain the liquid from the dishwasher. Many dishwashers of this general type incorporate food disposers, or chopper blades, in the drain system to chop larger particulates before pumping them out of the drain conduit. A typical dishwasher made for use in the United States is designed to use an average of approximately seven to twelve quarts of water per fill. The dishwasher is normally designed to incorporate a five fill cycle procedure that includes a pre-wash cycle, a rinse cycle, a main wash cycle and two final rinse cycles. If the machine performs all five of these cycles, sixty quarts of water could be used during the entire dishwashing procedure.

Dishwashers made for use in European markets normally do not comprise food disposers or chopper blades in the drain system. Instead, the filter system is designed to collect large food items which can then be removed by the user. These models of dishwashers typically use an average of three to four quarts of water per fill, but normally provide a five fill cycle procedure in a manner generally similar to dishwashers made for use in the United States. Dishwashers made for use in Europe differ from those made for use in the United States most significantly by their incorporation of individual drain pumps and recirculation pumps. Rather than using a reversing motor for both purposes, they provide a separate drain pump motor that can be used to purge the liquid from the dishwasher and another recirculation pump motor that can be used simultaneously to circulate water and cause the water to move into contact with surfaces of the dishes within the dishwasher. Some dishwashers use a turbidity sensor to monitor the turbidity of the water within the machine.

An example of a conventional dishwasher is disclosed in U.S. Pat. No. 5,800,628, entitled “Continuous Cycle Operation for Dishwashers Using Turbidity Sensor Feedback,” which issued to Erickson, et al. on Sep. 1, 1998, and which is assigned to Honeywell International, Inc. U.S. Pat. No. 5,800,628 is incorporated herein by reference.

Known dishwasher designs, whether they incorporate a turbidity sensor or not, operate in a manner which can be referred to as a “state” algorithm method. In other words, the machine changes completely from one state to another without the ability to assume intermediate states. More specifically, when a drain operation is performed, all of the liquid within the dishwasher is removed. If a new cycle is to be run, the container of the dishwasher is completely filled with clean water. Every time a cycle is run, the dishwasher is completely purged of its existing soiled water and then completely refilled with clean water.

One of the problems that plagues conventional dishwashers is that such devices do not adequately remove food and other particles that sticks to dishes placed in the dishwasher. When the typical washing cycle is complete, plates and dishes with “stuck on” food are usually not completely clean, which is a problem consumers find annoying. The problem with such “stuck on” soil (e.g., food soil) is that most people attempt to utilize the longest and hottest cycle to ensure the “stuck on” food will be removed from the dishes. This is not always effective and usually utilizes significantly more energy to accomplish the task. Additionally, the longer heat cycles usually damage special care or plastic items during the cycle.

It is therefore believed that what is needed to solve this problem is a special dishwashing cycle that guarantees 100% of food soil and other such particles will be successfully removed from the dishes. Such a cycle, including dishwasher methods and systems thereof, are disclosed herein.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for improved dishwasher methods and systems.

It is another aspect of the present invention to provide for improved dishwasher cycle control methods and systems.

It is a further aspect of the present invention to provide for an dishwashers equipped with turbidity sensors and humidity sensors.

It is an additional aspect of the present invention to provide for methods and systems for ensuring the complete removal of food soil and particles from dishes during automatic dishwasher cycles.

The aforementioned aspects of the invention and other objectives and advantages can now be achieved as described herein. Dishwasher cycle methods and systems are disclosed herein. In general, a dishwasher can be provided, which includes a humidity sensor for monitoring humidity with the dishwasher in order to provide optimum humidity and heat during a dishwashing cycle thereof, thereby allowing the humidity and heat to be modified in order to allow the food soil to soften for subsequent rinsing during a rinse cycle thereof. A turbidity sensor is also provided for automatically monitoring the turbidity within the dishwasher in order to detect a cleaning action thereof to determine if the soil has been released from the articles, such as dishes, contained within the dishwasher. Additionally, a spray injector can be utilized for injecting a spray into the dishwasher prior to the dishwashing cycle in order to release soil from articles contained therein and provide humidity for the removal of the soil.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a machine for washing articles in which a preferred embodiment can be implemented;

FIG. 2 illustrates a block diagram of a dishwasher system for washing articles, in accordance with a preferred embodiment;

FIG. 3 illustrates a humidity sensor, which can be adapted for use in accordance with a preferred embodiment;

FIG. 4 illustrates a turbidity sensor, which can be adapted for use in accordance with a preferred embodiment; and

FIG. 5 illustrates a high-level flow chart of operations, which can be implemented in accordance with a preferred embodiment.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

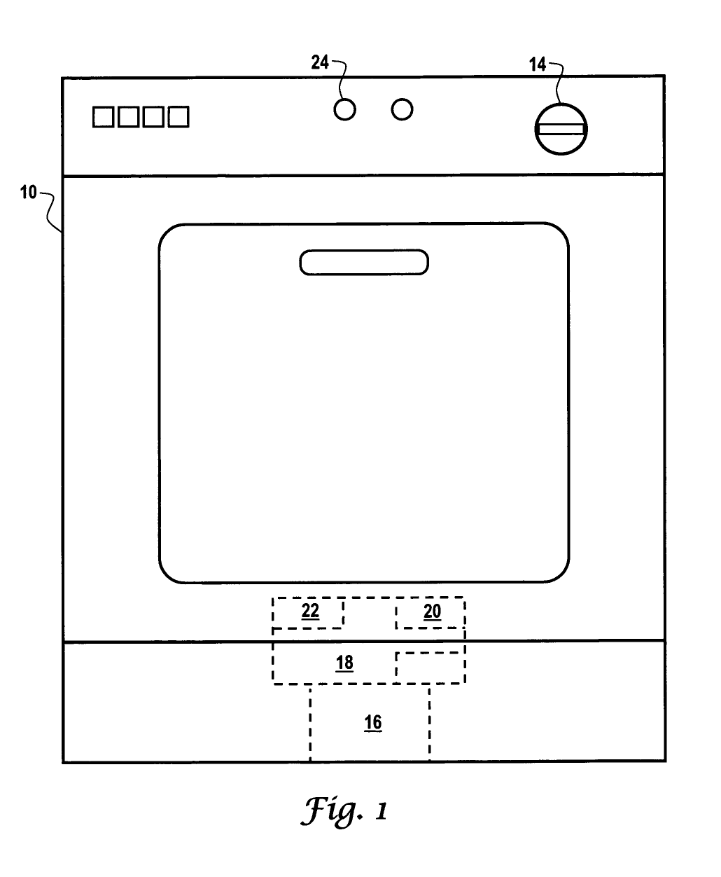

For the purpose of describing a preferred embodiment of the present invention, it will be discussed in terms of its inclusion within a dishwasher. FIG. 1 shows a typical dishwasher 10. A hand selectable timer 14 allows the operator to turn the dial of the timer to select a beginning point for the washing procedure and, as a result, select the overall length of the total washing procedure. In effect, the operator selects the beginning point of the cycle, at one of several optional starting points, and the end of the cycle is automatically controlled by the timer. Therefore, the selection of the starting point of the cycle will determine the overall length of the cycle and the number of drain and fill operations that will occur during this cycle. Within the structure of the dishwasher 10, a motor 16 causes a blade within a pump 18 to rotate. Although not specifically illustrated in FIG. 1, the motor 16 can also cause one or more wash arms to rotate and direct a spray of water, propelled by the pump 18, against articles such as dishes that are placed on racks within the opening of the dishwasher 10. The general operation of a dishwasher is well known to those skilled in the art and will not be described in detail herein.

With continued reference to FIG. 1, a turbidity sensor 20 can be disposed within the pump housing to monitor a magnitude of turbidity of the water passing through the pump housing. Alternatively, the turbidity sensor can be disposed within a conduit through which water passes during the operation of the dishwasher 10. Regardless of the location of the turbidity sensor, its function is to determine a magnitude of turbidity of the water within the dishwasher. As is well known to those skilled in the art, a turbidity sensor operates according to the principle that particulate matter suspended in water will affect the passage of light through the water. If light is transmitted along a line from a light source to a first photodetector, increased particular matter will decrease the light received by the photodetector. Alternatively, if the photodetector is placed at an angle from the light path emitted by the light source, it can receive light scattered by the particulate matter suspended in the water. In a typical operation, increased particulate matter will increase the amount of scattered light received by a photodetector disposed at an offset location from the light beam emitted by the light source and the light received by the photodetector in line with the light beam will decrease.

Skilled artisans in the field of turbidity sensing understand that the relationship is not a simple one and the comparison of scattered and transmitted light passing through a detection zone of particulate matter can be carefully analyzed and compared to each other in order to determine the type and quantity of particulates suspended in the water. These techniques are well known to those skilled in the art and will not be described in greater detail herein.

As indicated above, one of the problems that plague conventional dishwashers is that such devices do not adequately remove food and other particles that sticks to articles (e.g., dishes) placed in the dishwasher. When the typical washing cycle is complete, plates and dishes with “stuck on” food are usually not completely clean, which is a problem consumers find annoying. What is needed to solve this problem is a special dishwashing cycle that guarantees 100% of food soil and other such particles will be successfully removed from the dishes.

The embodiments disclosed herein therefore address these issues by disclosing a special cycle for dishwashers that removes “stuck on” food. Such a cycle modifies heat and humidity within a dishwasher, thereby allowing the food soil to soften. The problem with such “stuck on” food soil is that most people attempt to utilize the longest and hottest cycle to ensure the “stuck on” food will be removed from the dishes. This is not always effective and usually utilizes significantly more energy to accomplish the task. Additionally, the longer heat cycles usually damage special care or plastic items during the cycle.

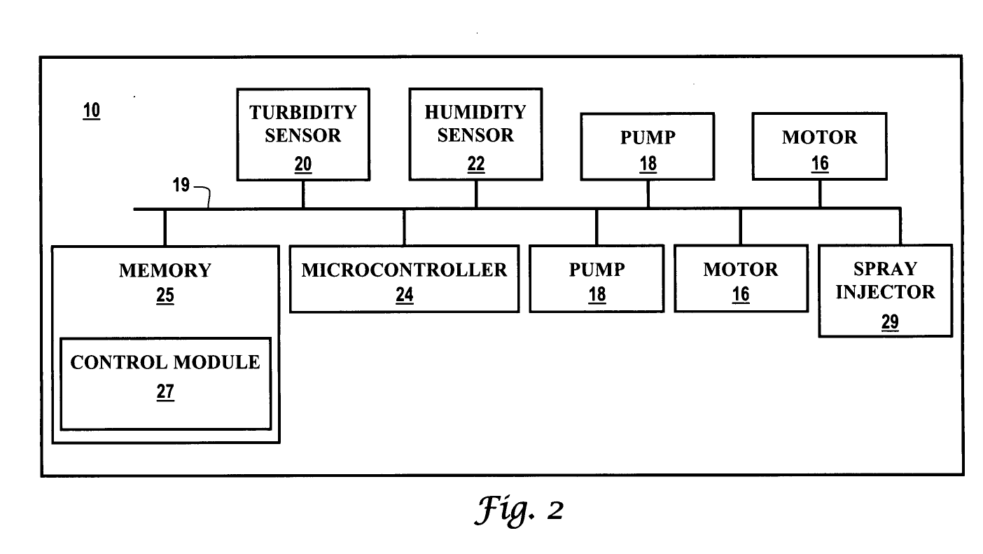

FIG. 2 therefore illustrates a block diagram of a dishwasher system 10 for washing articles, in accordance with a preferred embodiment of the invention. Note that in FIGS. 1-2, similar or identical parts or elements are generally indicated by identical reference numerals. Dishwasher system 10 of FIG. 2 is thus analogous to dishwasher 10 of FIG. 1. System 10 generally includes a turbidity sensor 20 and a humidity sensor 22, which are connected to a system bus 19. Additionally, a microprocessor 24 and a controller 26 can also be connected to system bus 19, along with pump 18, motor 16, a display unit 28, and a spray injector 29. System 10 can be implemented in the context of a dishwasher such as dishwasher 10 of FIG. 1.

In general, microprocessor 24 can be implemented as a central processing unit (CPU) on one or more integrated circuit (IC) computer chips. Microprocessor 24 can therefore operate as the computational control unit of system 10, either alone or in association with controller 26. Microprocessor 24 generally interprets and executes instructions. Microprocessor 24 can fetch, decode, and/or execute instructions and transfer information to and from other resources (e.g., pump 18, motor 16, spray injector 29, turbidity sensor 20, humidity sensor 22, and so forth) of system 10 over the main data-transfer path, system bus 19. Controller 26 can function as a control unit that performs an arbitrating or regulating function. For example, controller 26 can control access to memory 25 of system 10.

Humidity sensor 22 and turbidity sensor 20 are utilized to gain cycle information regarding the performance of the special dishwasher cycle described above that modifies heat and humidity within the dishwasher 10, thereby allowing food soil “stuck on” dishes to soften. Humidity sensor 22 generally monitors humidity so that the humidity within the dishwasher 10 can be controlled in the special dishwasher cycle to allow the food soften with time to permit the main wash cycle to clean effectively. Turbidity sensor 20, on the other hand, possesses a high accuracy in a low NTU range in order to monitor this soil realize and help ensure that the cycle is completely clean. Turbidity sensor 20 can be utilized in association with an algorithm for monitoring soil release and making the cycle most efficient.

System 10 (i.e., dishwasher 10) can also be equipped with a special spray, which can be injected into the dishwasher 10 by spray injector 29 depicted in FIG. 2 in order to help reduce and release “stuck on” food soil. Such a spray can be developed, for example, by detergent suppliers and can be injected into the special cycle described above for modifying heat and humidity within the dishwasher 10 immediately after a “pre-wash” cycle in order to help loose the food and provide the necessary humidity for initiating the food removal process.

Such a spray can also be periodically injected or “re-sprayed” into dishwasher 10 while the humidity sensor 22 continues to monitor the humidity within dishwasher 10 in order to maintain optimal conditions for soil softening and eventual release thereof from the articles (e.g., dishes) within the dishwasher 10. The spay can be configured to provide an enzymatic action for aiding in the release of the soil from the articles within dishwasher 10. In general, humidity sensor 22 ensures that the proper humidity is maintained for maximum release potential. A spray injector 29, which is also connected to system bus 19, can be utilized to inject such a spray into dishwasher 10 during the appropriate cycle.

The special cycle described herein can be configured so that loose food is removed initially in a pre-wash cycle and the spray injected into the dishwasher 10 immediately thereafter. Dishwasher 10 generally distributes the spray via spray injector 29 on the dishes located in dishwasher 10 and then pause until the action of food softening actually begins. Humidity sensor 22 is located within dishwasher 10 at a location that ensures that the optimum humidity and heat are maintained. The next portion of the cycle washes the dishes in a normal mode, while the turbidity sensor 20 monitors the cleaning action, thereby applying the algorithm described above in order to determine if the soil has stopped releasing from the dishes. The dishwasher 10 can then process a rinse cycle. Turbidity sensor 20 can then be utilized in the rinse cycle to reduce water consumption if the solution is determined to be very clean and additional rinses are not necessary. This is possible because turbidity sensor 20 can be configured to monitor very low NTU particulate.

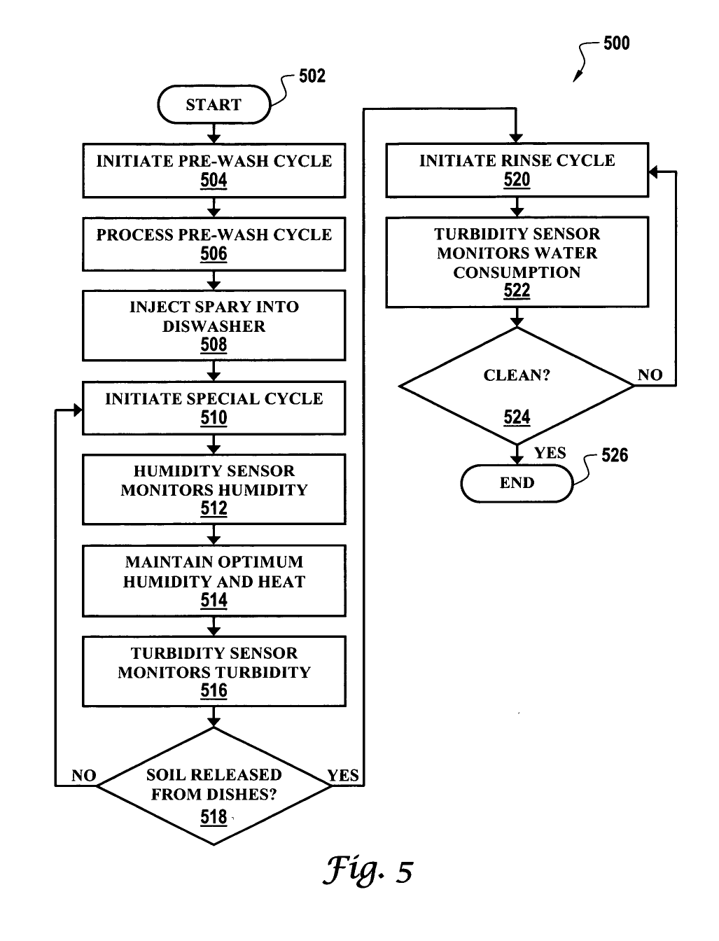

Note that system 10 can also include memory 25 that is also connected bus 19, and generally includes a control module 27 that resides within memory 25 and contains instructions that when executed on microprocessor 24, can carry out logical operations and instructions. Control module 27 can, for example, contain instructions such as those depicted in the flow chart 500 of FIG. 5 herein. Control module 27 can therefore implement a computer program product. It is important that, while the embodiments have been (and will continue to be) described in the context of a machine or device such as system 200, embodiments are capable of being distributed as a program product in a variety of forms, and that such embodiments can apply, equally regardless of the particular type of signal-bearing media utilized to actually carry out the distribution.

Examples of signal-bearing media include: recordable-type media, such as floppy disks, hard disk drives and CD ROMs, and transmission-type media such as digital and analog communication links. Examples of transmission-type media include devices such as modems. A modem is a type of communications device that enables a computer to transmit information over a standard telephone line. Because a computer is digital (i.e., works with discrete electrical signals representative of binary 1 and binary 0) and a telephone line is analog (i.e., carries a signal that can have any of a large number of variations), modems can be utilized to convert digital to analog and vice-versa. The term “media” as utilized herein is a collective word for the physical material such as paper, disk, CD-ROM, tape and so forth, utilized for storing computer-based information.

Control module 27 can therefore be implemented as a “module” or a group of “modules”. In the computer programming arts, a “module” can be typically implemented as a collection of routines and data structures that performs particular tasks or implements a particular abstract data type. Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based.

Thus, for example, the term module, as utilized herein generally refers to software modules or implementations thereof. Such modules can be utilized separately or together to form a program product that can be implemented through signal-bearing media, including transmission media and recordable media. A module can be composed of instruction media which perform particular instructions or user commands, such as, for example controlling the interaction of motor 16, pump 18, spray injector 29, turbidity sensor 20, humidity sensor 22, controller 26, microprocessor 26 and so forth.

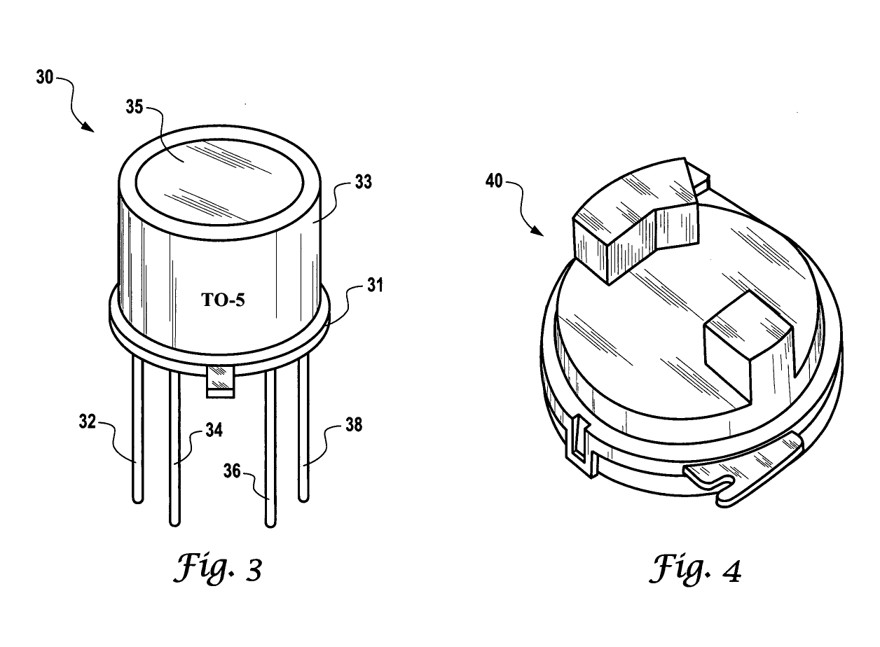

FIG. 3 illustrates a humidity sensor 30, which can be adapted for use in accordance with a preferred embodiment. Humidity sensor 30 can be utilized, for example, in order to implement humidity sensor 22 depicted in FIGS. 1-2. Humidity sensor 30 includes a top component 33 that includes a filter 35 (e.g., a 60μ pore hydrophobic SST filter). A contact 31 is located below top component 33 and includes a plurality of electrical contacts 32, 34, 36, and 38.

One example of a type of a humidity sensor, which can be utilized to implement humidity sensor 30 and hence, humidity sensor 22, is disclosed in U.S. Pat. No. 6,724,612, entitled “Relative Humidity Sensor with Integrated Signal Conditioning,” which issued to Davis, et al. on Apr. 20, 2004, and which is assigned to Honeywell International, Inc. U.S. Pat. No. 6,724,612 is incorporated herein by reference. U.S. Pat. No. 6,724,612 discloses a device that can be utilized to sense the relative humidity in the ambient environment around the sensor. During operation, the relative humidity level is sensed and then the sensor generates a voltage output proportional to the relative humidity. This voltage can then be used by other circuits to implement functions such as relative humidity control, enthalpy control for building HVAC, weather sensing instruments, process controls for drying, process controls for batch or continuous production where relative humidity is a parameter that controls the output of a process or is related to some process variable to be controlled, length or end of cycle in drying applications, and other applications.

FIG. 4 illustrates a turbidity sensor 40, which can be adapted for use in accordance with a preferred embodiment. Turbidity sensor 30 can be utilized, for example, in order to implement turbidity sensor 20 depicted in FIGS. 1-2. Turbidity sensor 40 can, for example, be implemented as the turbidity sensor disclosed in U.S. Pat. No. 6,456,375 B1, “Focused Light Turbidity Sensor Apparatus and Method for Measuring Very Low Concentrations of Particles in Fluids,” which issued to Ottens et al on Sep. 24, 2002, and is assigned to Honeywell International, Inc. U.S. Pat. No. 6,456,375 B1 is incorporated herein by reference. Such turbidity sensor can be utilized for example, to measure very low concentrations of particles in a fluid. The turbidity sensor disclosed in U.S. Pat. No. 6,456,375 B1 generally incorporates a laser light source for emitting laser light through a fluid.

Such a turbidity sensor can also include a first light-sensitive detector located 90 degrees to incident laser light emitted from the laser light source, and a second light-sensitive detector located at an angle obtuse to the incident laser light emitted from the laser light source, wherein the first and second light-sensitive detectors respectively measure side scattered light and forward scattered light reflected from particles contained within the fluid that come into contact with laser light emitted from the laser light source, thereby providing an accurate and reliable measurement of very low concentrations of particles within the fluid. The turbidity sensor disclosed in U.S. Pat. No. 6,456,375 B1 also includes a component for capturing incident laser light entirely emitted from the laser light source, thereby preventing reflection of the laser light back into the fluid. The laser light source may be a Vertical Cavity Surface Emitting Laser (VCSEL) or other light emitting light source.

FIG. 5 illustrates a high-level flow chart 500 of operations, which can be implemented in accordance with a preferred embodiment. As indicated at block 502, the process can be initiated for system 10 and hence dishwasher 10 illustrated in FIGS. 1-2. Thereafter, as illustrated at block 504, a pre-wash cycle can be initiated. Next, as depicted at block 506, the pre-wash cycle can actually be initiated. Thereafter, as illustrated at block 508, a spray can be injected into dishwasher 10 via spray injector 29. The release of the spray into dishwasher 10 via spray injector 29 helps reduce and release “stuck on” food soil and other particles. Releasing the spray into dishwasher 10 after the completion of the pre-wash cycle can help loosen food and provide the necessary humidity for the special cycle described earlier, which is initiated as indicated at block 510.

During the special cycle, the humidity sensor 22 can monitor humidity as indicated at block 512 within dishwasher 10 to ensure that proper humidity is maintained for release potential. Humidity sensor 22 can also be utilized to maintain optimal heat and humidity, as indicated at block 514. Thereafter, as depicted at block 516, a test can be performed to determine if all of the food soil and other particles have been released from the dishes in dishwasher 10. If so, then the process continues, as indicated at block 520. If not, the operations are repeated beginning with the operation illustrated at block 510. Assuming that the soil has been confirmed as released from the dishes, as indicated at block 520, a rinse cycle can be initiated. During such a rinse cycle, the turbidity sensor 20 can be utilized to monitor water consumption. Thus, turbidity sensor 20 can be utilized in the rinse cycle to reduce water consumption if it is determined, as indicated at block 20, that the dishes are very clean and additional rinses are not necessary. The process can thereafter terminate, as indicated at block 526.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A dishwasher cycle method, comprising the steps of:
injecting a spray into a dishwasher prior to a dishwashing cycle in order to aid in a release of soil from articles contained therein and provide humidity for the removal of said soil from said articles; and
automatically monitoring a humidity within said dishwasher in order to provide optimum humidity and heat during said dishwashing cycle, thereby allowing said humidity and heat to be modified in order to allow said soil to soften for subsequent washing or rinsing during a dishwasher cycle thereof.

2. The method of claim 1 further comprising the step of automatically monitoring a turbidity within said dishwasher in order to detect a cleaning action thereof to determine if said soil has been released from said articles.

3. The method of claim 2 further comprising the step of initiating a rinse cycle in response to monitoring said turbidity with said dishwasher.

4. The method of claim 2 further comprising the step of initiating a wash cycle in response to monitoring said turbidity was said dishwasher.

5. The method of claim 2 wherein said step of automatically monitoring said turbidity with said dishwasher further comprises the step of monitoring very low NTU particulates within said dishwasher during a rinse cycle.

6. The method of 1 further comprising the step of controlling said humidity in response to automatically monitoring said humidity within said dishwasher in order to soften said soil on said articles within said dishwasher.

7. A dishwasher system, comprising:
a dishwasher; and
a humidity sensor for monitoring humidity with said dishwasher in order to provide to provide optimum humidity and heat during a dishwashing cycle thereof, thereby allowing said humidity and heat to modified in order to allow said soil to soften for subsequent rinsing during a rinse cycle thereof.

8. The system of claim 7 further comprising:
a spray injector for injecting a spray into said dishwasher prior to said dishwashing cycle, wherein said spray aids in softening of said soil in order to aid in a release of soil from articles contained within said dishwasher and provide humidity for the removal of said soil.

9. The method of claim 8 wherein said spray injector periodically injects said spray into said dishwasher while said humidity sensor continues to monitor said humidity within said dishwasher in order to maintain optimum conditions for soil softening and eventual release thereof from said articles within said dishwasher.

10. The method of claim 8 wherein said spray provides an enzymatic action for aiding in said release of said soil from said articles within said dishwasher.

11. The system of claim 8 further comprising a turbidity sensor for automatically monitoring a turbidity within said dishwasher in order to detect a cleaning action thereof to determine if said soil has been released from said articles.

12. The system of claim 11 further comprising a module for initiating a rinse cycle in response to monitoring said turbidity with said dishwasher.

13. The system of claim 11 wherein said turbidity sensor monitors very low NTU particulates within said dishwasher during said rinse cycle of said dishwasher.

14. The system of 8 further comprising a controller for controlling said humidity in response to automatically monitoring said humidity within said dishwasher in order to soften said soil on said articles within said dishwasher.

15. The system of claim 8 further comprising a microprocessor for processing instructions for regulating said humidity and heat within said dishwasher based on data received from said humidity sensor.

16. The system of claim 15 wherein said microprocessor communicates with said turbidity sensor, said humidity sensor, said spray injector and a motor and a pump associated with said dishwasher.

17. The system of claim 8 wherein said humidity sensor monitors water consumption during a rinse cycle of said dishwasher.

18. The system of claim 15 wherein said microprocessor communicates utilizing a module for generating decisions, which aid in said release of said soil as determined by humidity data compiled from said humidity sensor turbidity data provided by said turbidity sensor during at least one dishwashing cycle associated with said dishwasher.

19. A dishwasher system, comprising:
a dishwasher;
a humidity sensor for monitoring humidity with said dishwasher in order to provide automatically monitoring a humidity within said dishwasher in order to provide optimum humidity and heat during a dishwashing cycle thereof, thereby allowing said humidity and heat to modified in order to allow said soil to soften for subsequent rinsing during a rinse cycle thereof;
a turbidity sensor for automatically monitoring a turbidity within said dishwasher in order to detect a cleaning action thereof to determine if said soil has been released from said articles; and
a spray injector for injecting a spray into said dishwasher prior to said dishwashing cycle in order to release soil from articles contained therein and provide humidity for the removal of said soil.

20. The system of claim 19 further comprising:
a controller for controlling said humidity in response to automatically monitoring said humidity within said dishwasher in order to soften said soil on said articles within said dishwasher, wherein said humidity sensor monitors water consumption during said rinse cycle of said dishwasher;
a microprocessor for processing instructions for regulating said humidity and heat within said dishwasher based on data received from said humidity sensor, wherein said microprocessor communicates with said turbidity sensor, said humidity sensor, said spray injector and a motor and a pump associated with said dishwasher;
a memory for storing said instructions for regulating said humidity and heat within said dishwasher based on data received from said humidity sensor; and
a control module stored within said memory for controlling said humidity sensor and said turbidity sensor and for modifying said humidity and heat within said dishwasher.
